(19) United States
(12) Patent Application Publication
(10) Pub. No.: US 2019/0186412 A1
(43) Pub. Date: Jun. 20, 2019

(54) Rebuildable Engine Casing and Oil Squirter Assembly for Air Cooled Internal Combustion Engines

(71) Applicant: Adamo P. Cultraro, Dana Point, CA (US)

(72) Inventor: Adamo P. Cultraro, Dana Point, CA (US)

(21) Appl. No.: 15/844,494

(22) Filed: Dec. 15, 2017

(51) Int. Cl. F02F 7/00; F01M 11/04; F01M 11/03

(52) U.S. Cl. CPC F02F 7/007; F01M 11/0408; F02F 7/0085; F02F 7/0021; F01M 2011/033; F01M 2011/0491; F01M 2011/0416; F01M 2011/035; F01M 11/03

(57) ABSTRACT

The present invention is directed to a rebuildable engine casing for an internal combustion engine supporting a plurality of pistons. The engine casing forms and provides a novel oil squirter that can readily be serviced or rebuilt. The engine casing also includes a novel mechanism for separating the case members and a removable service plug for accessing the oil galleries. The present invention also provides for a rebuildable oil squirter.

### BACKGROUND

### Technical Field

The present invention generally relates to the Field of casings for internal combustion engines and more particularly, to rebuildable engine casings and oil injection nozzle assemblies.

### Background

Internal combustion engines having a plurality of pistons have been used for years to provide power to vehicles. Typically, these engines arc built with an external casing, also known as an engine case, that is formed and machined to both protect and support the internal engine components, including the reciprocating pistons and piston rods. They also provide oil passageways or oil galleries allowing for motor oil to move throughout the engine to lubricate and cool the internal components. These engine casings generally include a pair of opposing case halves but may include other pieces to provide the desired support and a protective outer housing. Typical uses for such internal combustion engines are for powering vehicles, including automobiles.

To maintain performance and life, these engines may require servicing of their internal components. Moreover, the internal components and moving parts of all such internal combustion engines, eventually wear out. That leaves the option to replace or service the internal engine components. Alternatively, the entire vehicle is simply replaced due to the high cost of engine servicing.

In certain applications, including expensive, performance engines, servicing or rebuilding the engine is preferred. Moreover, rebuilding allows customization. Rebuilding necessarily requires the engine be taken apart, inspected and the internal components, repaired and serviced. A thorough cleaning of the engine is nearly universally recommended.

Generally, a first step in rebuilding and engine starts with separating the engine casing halves and any other members. Current methods of separating the members, however, are slow, considerable work and a challenging process. After the casing fasteners are removed, the casing members are slowly and methodically pried or otherwise worked apart. In addition, these efforts can leads to, damaging or warping the mating surface, which in turn leads to increased costs and rebuild time to repair and machine the damaged or warped surface. In addition, the case members can he damaged or even cracked while trying to separate the case members leading to the need to replace the expensive casing member. What is needed is an improved engine casing system and method that facilitates separating the engine casing members.

Another difficult aspect of servicing and rebuilding currently designed engines is servicing the oil passageways or galleries. While it is desired to thoroughly inspect and clean these galleries of oil residue, varnish and any debris, the lack of access to the galleries makes such cleaning difficult. What is needed is an improved engine casing that provides better access to the oil galleries to facilitate servicing and cleaning.

Many internal combustion engines use oil spray nozzles, often referred to as oil squirters to, lubricate and cool the pistons and lower piston cavities or chambers. In a typical application, the internal combustion engine, includes oil squirters adapted to spray oil into the piston cavity or even against the underside of each piston during operation. Each oil squirter assembly is a separate internal component that is press fit into a bore that is formed as part of an oil gallery connecting it to the oil pump.

As noted, a first problem with currently availably air cooled, internal combustion engine casings and particularly when rebuilding them is separating the case or casing members. As also noted, a second problem when servicing or rebuilding them is accessing the oil galleries for servicing and cleaning. Another problem is identifying and repairing clogged or even plugged oil injection nozzles or squirters. Or even servicing the oil squirters to ensure they are operating as originally designed. Moreover, these oil squirters are a fixed design and not serviceable components. They are neither repairable or rebuildable.

Common efforts to clean, existing oil squirters include spraying or soaking with a chemical cleaning agent into an open end of the nozzle, waiting, repeating and using compressed air to clear the oil passageway. Others have used thin wire and solvent to first inspect and then physically clear any debris or obstructions. While these solutions may clear obstructions, they may also unwittingly damage the internal spring and plug or valve assembly. One is also unable to truly know how clear the nozzle passageway is or the actual its condition and stability of the nozzle, without removing and physically inspecting each one. Moreover, these cleaning efforts require significant time and risk of damage to the desired flow and stability characteristics of each nozzle.

Removing and replacing injection nozzles when rebuilding is possible but requires significant time, effort and possibly even specialized tools. These efforts may include machining, drilling out each pressing in nozzle and then pressing in a replacement one. Such efforts have the risk of leaving metal debris within the oil passageways. Moreover, if replacing, one risks altering the desired orientation, flow and stability of each nozzle. And replacing increase the chance of damaging the much more expensive and difficult to replace engine casing. What is needed is an improved engine casing and oil squirter that facilitates rebuilding and the servicing and cleaning of the squirters.

### SUMMARY

The present invention provides a rebuildable engine case, also referred to as an engine casing, for an air cooled, internal combustion engine supporting internal engine components, including reciprocating pistons. The engine casing Rams and provides oil galleries, often referred to herein collectively as an oil gallery, that allows oil to move from an oil pump source to every piston cavity or chamber and back again.

The engine casing includes a first case member or casing half that has a flat planar mating surface at one end. The engine casing also has an opposing case member or opposing half that also forms a second flat mating surface. The case members form shell like structures as is common in the art. The two planar mating surfaces are adapted to fit together to form a sealed housing for the engine components. The mating surfaces are also specifically designed to be separated from each other to facilitate servicing and rebuilding of is the engine without some of the challenges and difficulties common with current engine casings.

The engine casing provides an integrated mechanism and method for separating is the engine case members to facilitate servicing or rebuilding the engine internals. This mechanism provides threaded bores within and passing through the mating surface of one of the engine casing halves. Each bore being substantially perpendicular to the flat mating surface. The bores are designed to mesh with a threaded pushrod or even an engine bolt such that when threaded into the bore, the pushrod contacts the opposing mating surface, or adjacent to the mating surface. As the pushrod is further threaded into the bore, it increasingly presses against the mating surface of the second engine case member. The engine case members are secured together at their mating surfaces using fasteners as known in the art. These fasteners must be removed before actuating the case separating mechanism.

The engine casing further, incorporates internal structures forming oil galleries, piston chambers and support structures for the various internal engine components. The internal structure of the engine casing includes an internal bore cylindrical oil squirter port that is adapted to receive an oil squirter and preferably, the novel oil squirter a the present invention. In one embodiment, an oil squirter is inserted into each cylindrical squirter port and secured using a temperature sensitive adhesive.

As noted, the oil squirter has a tubular body that fits within the internal bore of the casing. More specifically, the tubular body has one end, referred to its a receiving end, that is adapted to be inserted into the squirter port so that it creates a continuous oil passageway from the oil gallery through the hollow tubular oil squirter body. The internal passageway of the receiving end includes structure that can work with an inserted valve or plug to control the flow of oil through the tubular body. The tubular body extends along the cylindrical axis of the squirter port to a second end, referred to herein as the discharging end. The discharging end may advantageously be fitted with an outwardly protruding flange and internal threads.

A removable oil squirter cat is connected to the discharging end of the tubular body. This cap extends from the discharging end of the tubular body into the piston chamber and includes a passageway extending from passageway in tubular body and out through a second end having an mice such that it when it receives oil from the tubular passageway, that oil can be squirted out of the orifice and into the piston chamber. The oil squirter cap has a first or receiving end that is adapted to be both attached and removed from the discharging end of the tubular body such that is can be removed to service the oil squirter assembly during an engine service or rebuild. Preferably, the receiving end of the cap is fitted with external threads that fit within and mesh with mating internal threads within the discharging end of the tubular body.

In addition to the orifice, the second or external end of the squirter cap also includes a mechanical configuration that allows use of a mechanical tool when installing or removing it from the tubular squirter body. The mechanical configuration may be a screwdriver groove within the top exterior surface of the cap. The second end of the squirter cap is configured as a flange relative to the first end. The flange configuration cap is adapted to but up against the external flange on the discharging end of the tubular body.

A coil spring and plug or valve member are fitted within the tubular body and secured in place by the cap. The spring and valve control the flow of oil through the oil passageway. A variety of different springs and valve members are contemplated.

The engine casing also includes a threaded opening or port that directly accesses an oil gallery. This threaded opening includes interior threads within the wall of the casing member, which are designed to mesh with a threaded oil gallery plug. The plug includes external threads that can be threaded into or removed from the oil gallery servicing port to improve and simplify servicing of the oil gallery and oil components along the path of the gallery.

The present invention further provides an engine casing for an air cooled internal combustion engine having rebuildable oil squirters that, are manufactured as part of the engine casing. These integral oil squirters eliminate the need for multiple parts and are similarly serviceable through a novel removable oil squirter cap.

In this embodiment, the engine casing is designed and machined such the internal oil squirter bores are machined to the same tolerances as the tubular body of removeable oil squirter. This embodiment of the oil squirter bore includes internal threads machined into the engine casing at the discharging end and a valve seat at the base of the bore or the receiving end. A flat surface, like a flange on the removable squirter, is machined into the engine easing at the exit end of the squirter bore within each the piston chamber. A spring and valve member are inserted into the squirter bore and the novel squirter cap of the present invention is threaded into the squirter bore. Not only can the squirter cap be removed to clean and service the squirter passageway, internal components and even the access the oil gallery passageway, it can also be changed out for a new cap to alter the orifice configuration or direction.

### BRIEF DESCRIPTION OF THE DRAWINGS

FIG. 1 is a perspective view of an embodiment of an engine casing of the present invention.

FIG. 2 is an end view of the engine casing of FIG. 1 showing case members separated.

FIG. 3 is a side view of the engine casing of FIG. 1.

FIG. 4A is an end view of a case member of the present invention as also depicted in FIG. 4B.

FIG. 4B is an internal side view of a first member of the engine case of the present invention.

FIG. 4C is an opposing end view of the member of the engine case of FIG. 4B.

FIG. 4D is a cross sectional bottom view of the engine case member depicted in FIG. 4B showing a removable oil gallery plug of the present invention.

FIG 5 A is an end view of a second case member of the engine casing of the present invention.

FIG. 5B is an internal side view of the second member of the engine casing of the present invention.

FIG. 5C is an end view of the second member of the engine case depicted in FIG. 5B.

FIG. 6A is a partial detailed view of the engine case depicted in FIG. 1 showing an embodiment of the case separating mechanism of the present invention.

FIG. 6B is a partial detailed view of the engine case of FIG. 4 showing the removable oil gallery plug of the present invention.

FIG. 7 is an exploded view of one embodiment of the piston oil squirter of the present invention.

FIG. 8A is a top view of piston oil squirter of the present invention.

FIG. 8B is a side view of the piston oil squirter of the present invention.

FIG. 8C is a bottom view of the piston oil squirter of the present invention.

FIG. 9 is a cut away side view of the housing for an embodiment of the piston oil squirter of the present invention.

FIG. 10A is a side view of an embodiment of the cap of the piston oil squirter of the present invention.

FIG. 10B is a cross sectional view of an embodiment of the cap of the piston oil squirter for the present invention.

FIG. 10C is a top view of an embodiment of he cap of the piston oil squirter for the present invention.

FIG. 11A is a side cut away view of an engine casing for a piston engine showing the placement of the piston oil squirter of the present invention.

FIG. 11B is a partial view inside a piston engine casing showing the placement of the piston oil squirter of the present invention.

FIG. 11C is partial cross-sectional view of the internal walls of one portion of the engine casing of the present invention showing a preferred location of the piston oil squirter.

FIG. 12A is an external perspective view of a first half of an engine casing of the present invention.

FIG. 12B is a detailed perspective view of the half of an engine casing of FIG. 12A, showing a preferred location for an embodiment of an integrated piston oil squirter of the present invention.

FIG. 12C is a further detailed view of FIG. 12B, showing, an exploded, view of the embodiment of the piston oil squirter of the present invention,

FIG. 12D is a partial sectional view of the engine casing of FIG. 12A showing the bore connecting the integrated oil squirter to the main oil gallery.

### DETAILED DESCRIPTION OF THE INVENTION

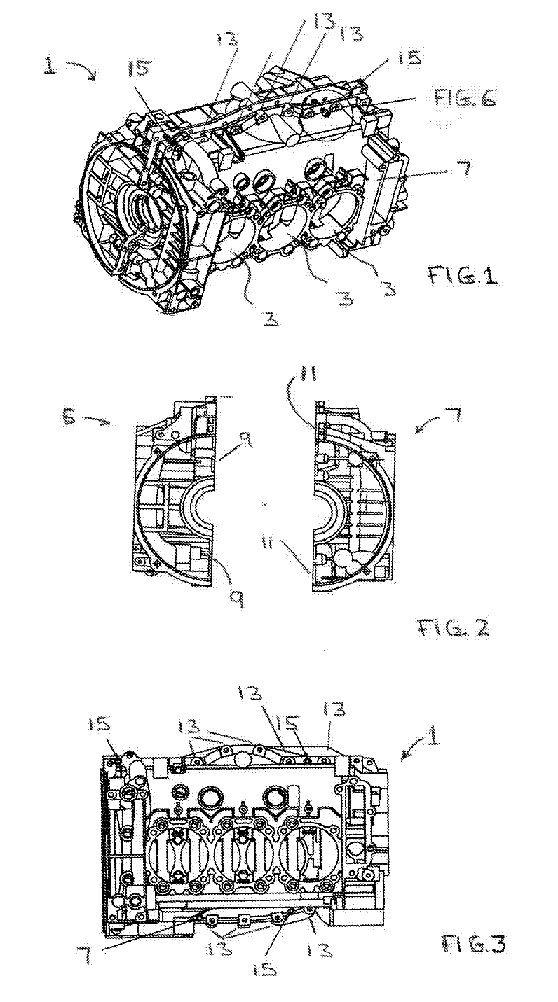

Referring to FIG. 1 of the drawings, the present invention is directed to a rebuildable engine case 1 or housing, also referred to as an engine casing, for an air cooled, internal combustion engine supporting a plurality of reciprocating pistons (not shown). Like existing engine cases, the engine casing 1 of the present invention forms and provides supporting structure for internal engine components, including the pistons, piston rods and crank (not show). The engine casing 1 also forms internal oil passageways or galleries, often referred to herein collectively as an oil gallery, that allows oil to move from the oil pump (not shown) to every piston and piston rod chamber 3 and back again. The improved engine case allows improved access to repair and rebuild the engine components it supports and houses.

Referring no to FIG. 2, a preferred embodiment the engine casing 1 is formed from two case member halves 5 and 9. Other embodiments may include additional or differing configurations of case members to form the same engine casing of FIG. 1. In this preferred embodiment, a first case member 5 or case half is designed to be mated to and secured against an opposing second case member 7 or half. A gasket (not shown) or other sealing agent may be used to seal the case members together. More specifically, the first or left case member 5 includes a flat planar surface 9 and the opposing second or right case member 7 is formed having an opposing or second planer surface 11. The opposing right and left mating surfaces 9 and 11 are designed to mate and be secured and sealed to each other with the casing member bodies 5 and 7 extending away to form the rebuildable engine casing of the present invention as shown in FIG. 1 and FIG. 3. The use of the terms first and second or right and left are only used herein to designate the opposing pieces and not to any specific engine application.

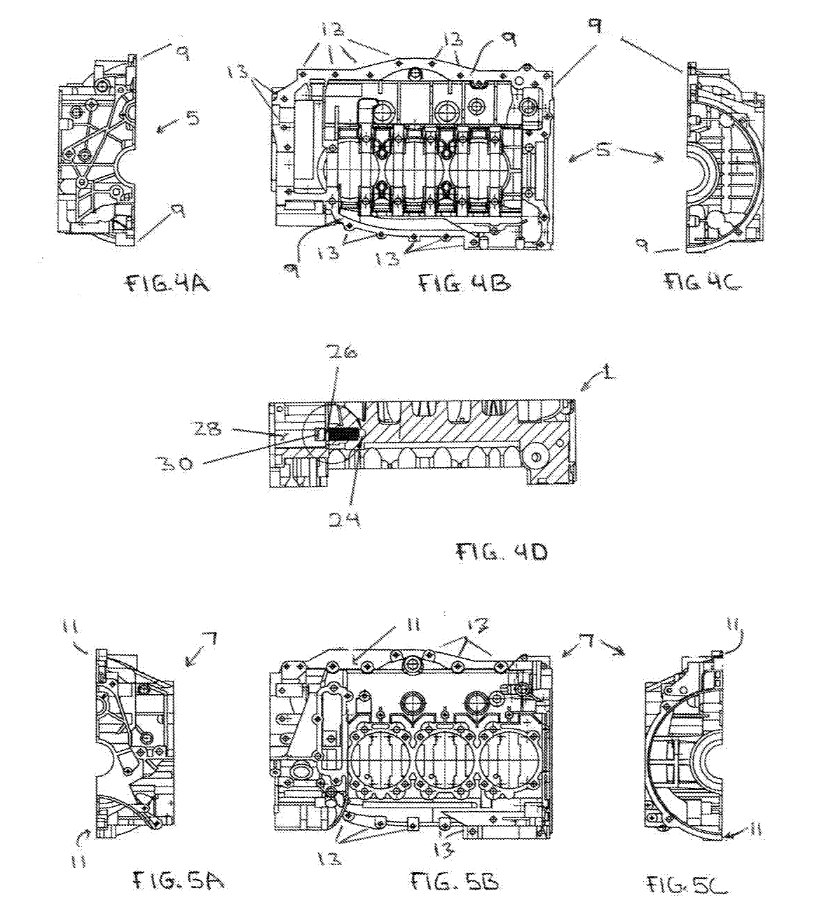

Referring now to FIGS. 1 through 3 and as further illustrated in FIGS. 4 and 5, left case member 5 and right case member 7 include opposing attachment points 13 along or adjacent to the mating surfaces 9 and 11. In a preferred embodiment, the attachment points of the case member, are bolt holes or bores spaced apart along each opposing planar mating surface 9 and 11 to allow the use of bolts or other threaded fastener. In another embodiment, fastener holes or bores 13 are spaced apart along one of the planar surfaces 9 or 11 and the opposing planar surface has mating bores with internal threads for receiving an engine case bolt (not shown). Alternatively, the engine casing members 5 and 7 may be secured together using any method or means that can also be removed to allow for the separation of the members from each other for service or rebuilding.

Referring now to FIGS. 1, 3 and 6, the engine casing 1 of the present invention also provides an integrated case separating mechanism 15 and method for separating the engine case members 5 and 7 to allow for servicing or rebuilding the engine internals. In a preferred embodiment, the engine casing 1 includes a plurality of case separators 15 spaced apart along or adjacent to the mating surfaces 9 and 11. Traditionally, splitting or separating the engine housing members was tedious and often resulted in damaging the mating surfaces or worse, cracking one of the casing member. The case separators 15 of the present invention advantageously allow the case members 5 and 7 to be slowly and methodically separated while substantially reducing the risk of damaging the case members or mating surfaces. In other embodiments having additional casing members, the case separators 15 of the present invention are spaced apart along the mating surfaces of all these casing members.

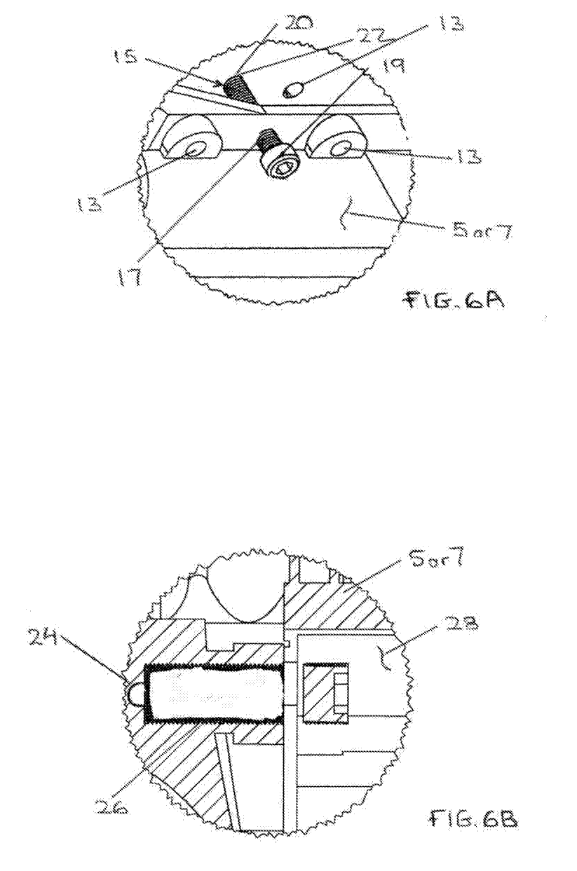

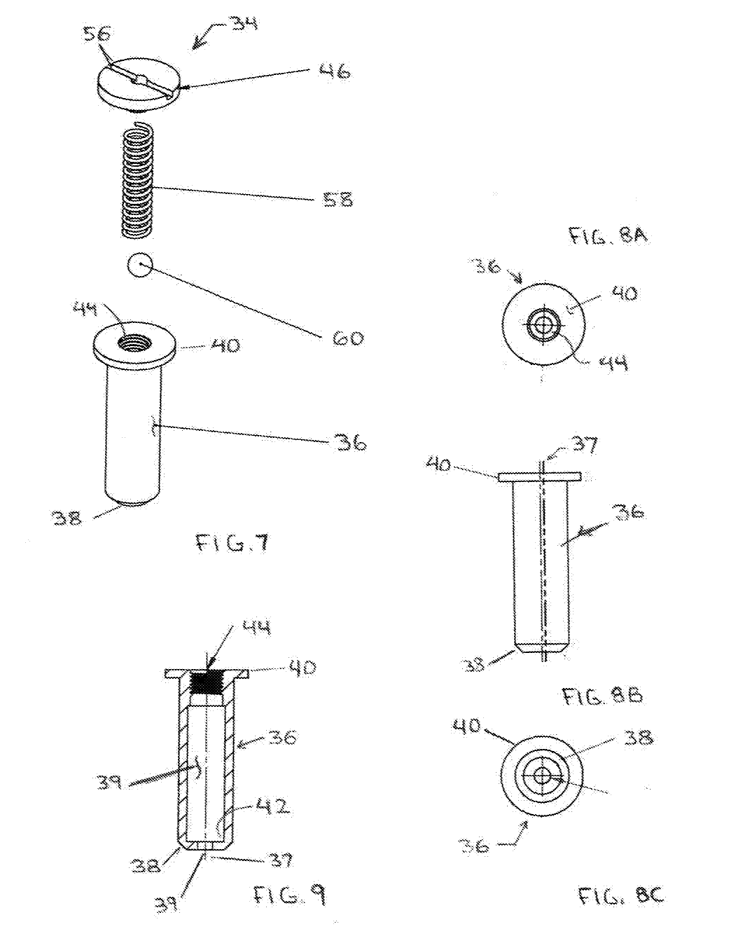

Referring now to FIG. 6A, in a preferred embodiment, each case separator 15 includes an internally threaded bore 17 passing through the planar mating surface 9 or 11 of one of the case members 5 or 7. The threaded bore 17 is axially perpendicular to the planar mating surface 9 or 11 it passes through. The threaded bore 17 is axially aligned such that when an externally threaded pushrod, bolt or similar device 19 is threaded into it, the pushrod end 20 contacts against the opposing planar mating surface 9 or 11 of the opposing case member. Preferably, the alignment is such that the maximum surface area of the pushrod end 20 contact the mating surface 22. To support the force of the pushrod 19 pressing against it. the opposing case member 5 or 7 may have a hardened or specialized surface 22 aligned where the pushrod end 20 contacts it.

In a preferred application, a threaded bolt 19, such as a hex head fastener is provided within each threaded bore 17. A temporary thread locking adhesive or similar may be applied to prevent the bolt 19 from coming unthreaded during engine transportation and use. Whenever the engine casing 1 is desired to be serviced or rebuilt, and opposing case members 5 and 7 separated, the threaded fasteners are individually threaded further into the bore 17 of case ember 7 such that the bolt increasingly presses against the mating surface 22 of the opposing engine case member 5. The case separators 15 are preferably positioned near or even adjacent to the fasteners used to secure the case members Obviously, the fasteners securing the engine case members 5 and 7 (not shown) would first be removed or at least substantially loosened prior to substantially actuating the case separator 15.

Preferably, the case separators 15 are each incrementally actuated, one at a time, such that the force exerted by them on the opposing case member, is evenly distributed across the planer mating surfaces. In a preferred embodiment, the pushrods 19 are actuated (threaded inward) in a cross pattern similar to tightening lug nuts on a wheel assembly. In a preferred embodiment of the engine casing 1, where the case separators do not include pushrods, the threaded bores 17 are of a standard fastener size, such as ¼ inch or 8 mm diameter, allowing a user to readily obtain and utilize such sizes.

Referring now to FIGS. 1, 4D and 6B, the engine casing 1 also provides internal structures forming oil galleries to allow for the passage of engine oil. More specifically, the engine casing 1, when assembled, is formed having and provides a series of oil galleries 24. As known in the art, the oil galleries connect to form passageways for engine oil to move to and from the oil pump (not shown) throughout the engine to cool and lubricate internal components (also not shown). As is also known, these oil galleries require cleaning and servicing particularly, when rebuilding the engine and that accessing them for a thorough service and cleaning is very difficult if not impossible. The engine casing 1 of the present invention advantageously provides for cleaning these oil galleries 24 by providing a cleaning port 26 at an accessible location 28 within the engine casing 1. Preferably, the engine casing 1 includes a plurality of cleaning ports to facilitate the cleaning and servicing of all the oil galleries not otherwise accessible.

In a preferred embodiment, the cleaning ports 26 are cylindrical bores having internal threads. The bores fluidly connect with an oil gallery 24 and are preferably located within a section of the engine casing 1 and sized to allow access for serving, including the use of pneumatic and vacuum tools.

An oil gallery plug 30 is used to seal each oil gallery port 26. In a preferred embedment, the plug 30 is a conventional threaded plug having external threads that mesh with the internal threads of the service port 26. Thread sealer and adhesive may be used to ensure the plug 30 and port seal and the plug does not become prematurely loose. To access the oil galleries 24 during servicing or rebuilding of the engine, the gallery plugs are simply unthreaded from the oil gallery ports.

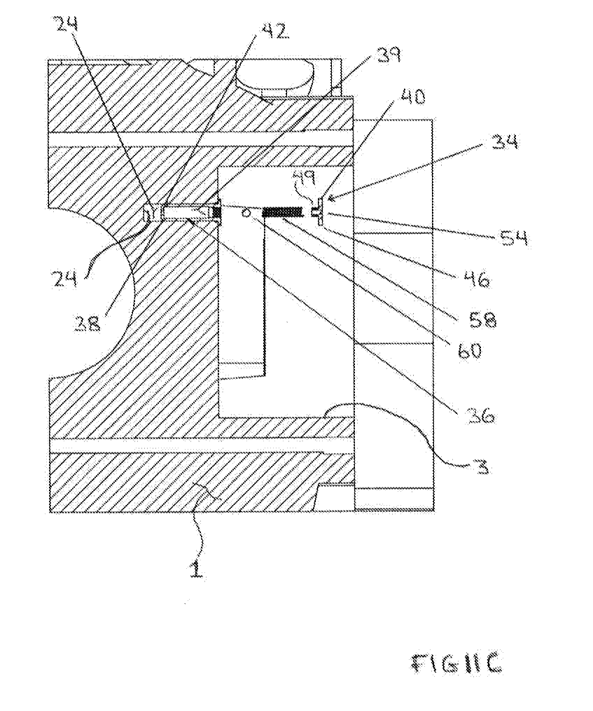

In addition to oil galleries, the present engine casing provides for conventional oil nozzles or, squirters. The internal structure of the engine casing 1 includes an internal bore or cylindrical oil squirter port that connects the oil gallery to each piston chamber. This internal bore as shown in FIG. 11C is adapted to receive an it squirter as conventionally known.

Referring now to FIGS. 7 through 10, a preferred embodiment of the present invention includes a novel oil squirter assembly 34 of the present invention. In this embodiment, the oil squirter 34 is preferably slip fit into each cylindrical squirter port 32. A high grade and high temperature adhesive is used to secure the squirter 341 within the bore 32. Preferably an aircraft grade metal adhesive such as that currently available from Henkle under the name Loctite 640 may be used. If needed, the oil squirter assembly 34 can be advantageously removed using heat, above the highest engine temperature and adhesive rating, to break down the adhesive and allow removal without destruction of the squirter as in the prior art. The squirter 34 can then be serviced and reinserted using new adhesive. The present squirter assembly 34 may be used to replace existing oil squirters when rebuilding many prior art conventional air cooled multiple piston engines or as part of the engine casing assembly 1 of the present invention.

The oil squirter assembly 34 has a tubular body 36 that, as noted, tits within the internal bore of the casing member. More specifically, the tubular body 36 has a receiving end 38 that is adapted to be inserted into the squirter bore or port 32 so that it creates a continuous oil passageway 39 from the oil gallery (not shown in FIG. 7) through the hollow tubular oil squirter body 36. In a preferred embodiment, the exterior surface of the tubular body 36 is tapered at the receiving end 38 inward towards the adjacent oil passageway 39. The taper 38 advantageously facilitates alignment with the oil squirter bore 32 within the engine casing 1 (FIG. 11C).

The tubular body 36 extends from the receiving end 38 within the squirter bore 32 outward along its, cylindrical axis 37 to a second or discharging end 40. In a preferred embodiment, the second, end 40 is a flange having a larger diameter than the tubular body 36. The flange 40 advantageously seats the oil squirter assembly 34 against a flat surface within the piston cavity or chamber or chamber 3 and aligns it within the squirter bore 32. In another embodiment, the engine casing 1 may include a larger counter bore within the oil squirter bore 32 such that the tubular body and flanged end 40 are flush, or even, below the casing surface forming the base or side of the piston chamber 3.

In a preferred embodiment, the internal passageway 39 at the receiving end 38 of the tubular body 36 forms an internal valve seat 42 and,internal threads 44 are provided within the discharging end 40. The tubular body 36 is prefer ably made from a single piece of metal, such as a steel or other high strength metal (relative to the generally aluminum casing), but any material or combination of materials may be used that can tolerate engine stresses and temperature conditions and not be damaged during installation. For example, the tubular body 36 may have a metal outer shell with a lining or partial lining to facilitate forming the valve seat 42, flange, internal threads or even for facilitating the function of any internal components.

The oil squirter assembly 34 of the present invention includes an oil squirter cap or orifice plug 46 that is removably attached to the discharging end 40 of the tubular body 36. This oil squirter cap 46 has a first or receiving end 48 that is adapted to be both attached and removed from the discharging end 40 of the tubular body 36 such that it can be removed to service the oil squirter 34 during an engine rebuild. Preferably, the receiving end 48 is fined with external threads 49 that mesh with mating internal threads within the discharging end 44 of the tubular body 36. A non-permanent thread, sealant and lock, such a one from Loctite or Henkel, may be used to ensure the cap 46 remains threaded within the tubular body 36 but still can be removed for servicing, such as cleaning and accessing the internal components.

The cap 46 has a hollow passageway 50 that extends from its receiving end 48 to an opposing external or discharge end 52. This passageway 50 allows for the oil that is pumped into the tubular body 36 of the oil squirter 34 to pass through the cap and be pumped into the piston chamber as can be seen in FIGS. 11A, 11B and 11C. In a preferred embodiment, the discharge end 52 includes or forms an orifice 54 that can be adapted to provide the desired oil squirting characteristics, including flow, pressure, volume and discharge direction. In the preferred embodiment illustrated, the orifice 54 is an opening machined directly within the discharging end 52 that ties into the passageway 50 passing through the cap 46.

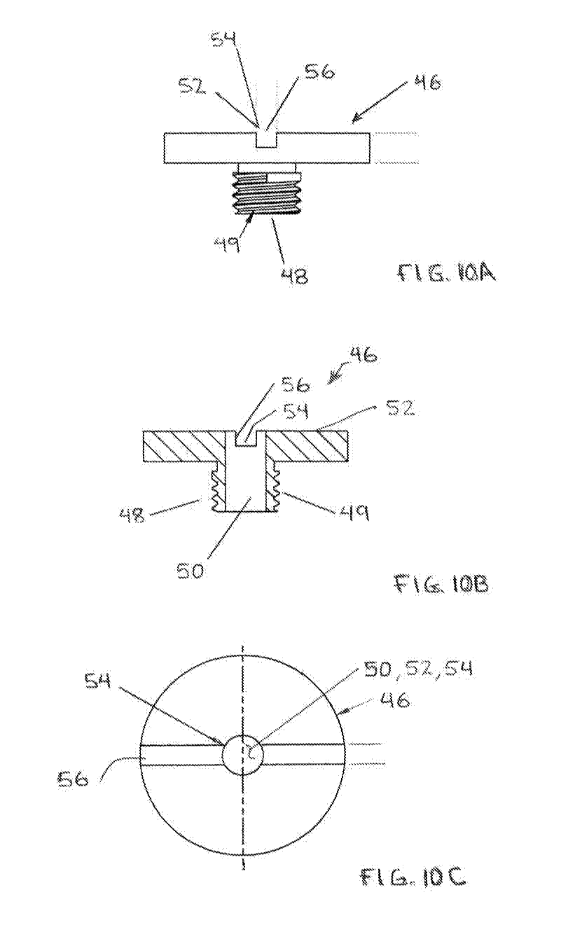

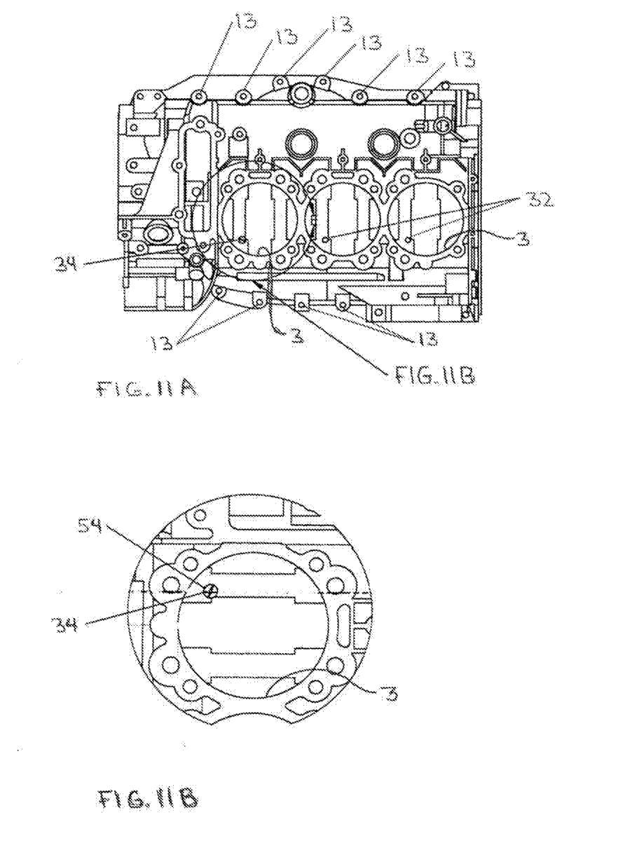

In a preferred embodiment, the external or discharging end 52 of the squirter cap 46 provides a mechanical configuration 56 that allows use of a mechanical tool when installing or removing it from the tubular squirter body 36. This mechanical configuration 56 advantageously allows the use of a tool, such as a screw driver, other driver, or wrench, to assist in installing and removing the cap 46 with thee tubular body. In a preferred embodiment illustrated in FIG. 10, the mechanical configuration 56 may be a screwdriver slot or groove provided within the top exterior of the discharging end 52 of the cap 46. Alternatively, any other tool receiving or meshing configuration may be provided as part of the discharging end 52 of the cap 46, such as, for example, a Phillips head or Torx socket, an Allen, hexagonal or other socket or any other configuration adapted to receive a driver or other tool.

In the preferred embodiment shown, the discharging end 52 of the squirter cap 46 is configured to provide a flange or larger surface relative to the first end 48 of the squirter cap. During installation, the under surface of the flange 52 is adapted to contact and butt up against the outer surface of the external flange on the discharging end 40 of the tubular body 36. The flange end of the cap 52 may also be configured as a hex head or other bolt configuration to allow use of a wrench or the like when installing or removing it.

The cap 46 is preferably made from a single piece, of steel or high strength metal but any material or combination of materials may be used that can tolerate engine stresses and temperature conditions. For example, the cap 46 may be constructed from a high strength durable composite, ceramic, plastic or be made from a metal with a replaceable plastic orifice.

When installed as illustrated, the cap 46 extends from its receiving end 48, which is threaded into the discharging end 40 of the tubular body 36, outwardly and into the piston cavity 3 (FIG. 11C). The oil passageway 50 through the cap 46 provides a continuous oil passageway that extends from the oil gallery squirter bore 32, though the oil passageway 39 in the tubular body 36 and out through the orifice 54 in the cap 46 such that it when the, oil squirter assembly 34 receives pressurized oil from the oil gallery, that oil is squirted out of the orifice and into the piston cavity 3.

In a preferred embodiment, the oil squirter assembly 34 includes a coil spring 58 and valve member 60. More specifically, a compression spring 58 and valve 60 are fitted within the tubular body 36 and secured in place by the removable cap 46. The spring 58 is preferably a coil spring as known in the art though a variety of different springs that can apply pressure to the valve are contemplated. The valve 60 is used to generally seal against the valve seat 42 within the tubular body 36. The spring 58 pushing against the valve 60 seats it against the valve seat 42 as is also known. When oil pressure within the oil squirter bore 32 is sufficient to overcome the spring force, the valve 60 is pushed back from the valve seat and oil flows into the tubular body 36 and out the orifice 54 In a preferred embodiment, the valve 60 may be a sphere but any configuration that provides sufficient sealing against the valve sear t 42 may be used. The spring 58 and valve 60 are preferably made from a metal, including a spring steel, but the valve may also be made from other materials such as a plastic or ceramic.

The oil squirter assembly 34 is designed to serviced by simply removing the cap 46 from the tubular body 36. The removeable cap 46 also allows flexibility when installing or modifying the internal components. For example, the described spring 58 and valve 60 may be installed either with after installing the tubular body into the engine casing 1. Alternatively, one could wait until they were ready to actually build or rebuild the engine within the engine casing assembly 1 of the present invention to install a specific spring and valve or change out to a differing set, or even a different set of internals, allowing much greater flexibility in determining things like flow, pressure or other attributes desired from the squirter assembly. The oil squirter assembly 34 may also be cleaned while installed in the engine casing 1 or after being removed.

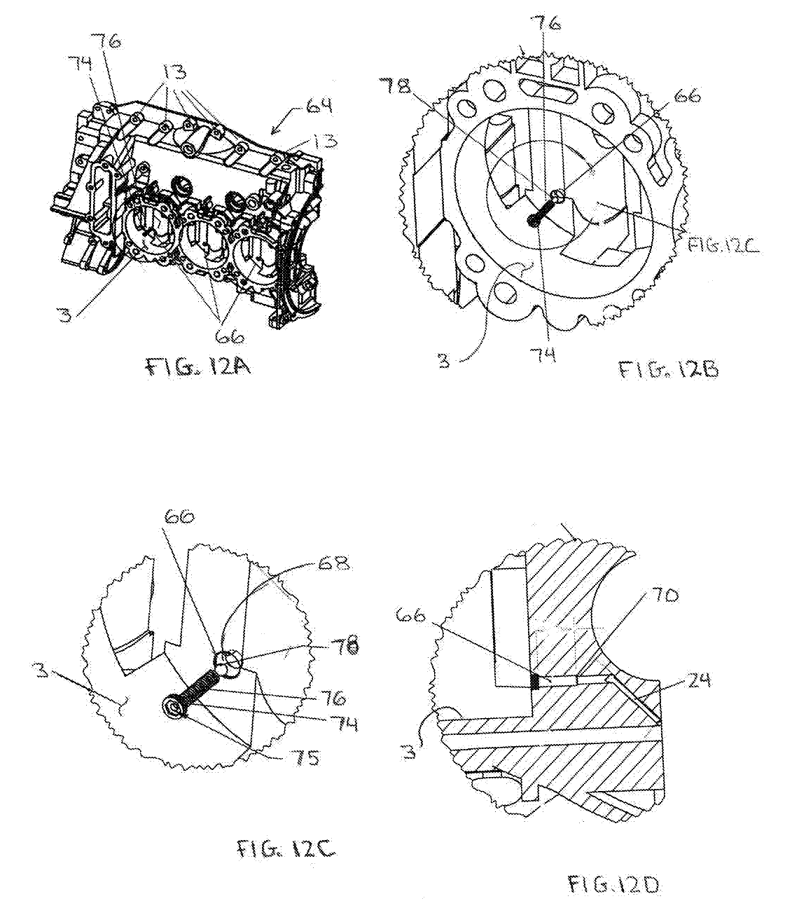

Referring now to FIGS. 1 and 12A through 12D, the present invention further provides an engine casing for an air cooled internal combustion engine having rebuildable oil squirters that are manufactured as part of the engine casing. These integral oil squirters eliminate the need for multiple parts and are similarly serviceable through a removable oil squirter cap.

In this embodiment, the engine casing 64 is designed and machined or otherwise provides for internal oil squirter bores 66 that have a similar diameter as the internal passageway 39 of the tubular body 36 of the prior embodiment shown in FIG. 9. This is embodiment of the oil squirter bore 66 includes internal threads 68 that are machined or otherwise formed into the engine casing 64 at the opening or discharging end. Internally a valve seat 70 is provided at the receiving end or base of the oil squirter bore 66 where it joins with the oil gallery 24. A flat surface 72, such as a flange, is machined into or otherwise provided on the engine casing 64 at the exit or discharging end of the oil squirter bore 66 within each piston chamber 3.

An externally threaded plug or cap 74 having an oil passageway and orifice is removably threaded into the mating threads within the oil squirter bore 66. In a preferred embodiment, the external or discharging end of the squirter cap 74 provides a mechanical configuration 75 that allows use of a mechanical tool when installing or removing it from the integral oil squirter bore 66. This mechanical configuration 75 advantageously allows the use of a tool, such as a screw driver, other driver, or wrench, to assist in installing and removing the cap 74 with the threaded bore 66. In a preferred embodiment illustrated in FIG. 12C, the mechanical configuration 75 may be an hexagonal socket provided within the top exterior of the discharging end of the cap 74. Alternatively, any other tool receiving meshing configuration may be provided as part of the discharging end of the cap 74, such as, for example, a Phillips head or Torx socket, a screwdriver or other socket or any other configuration adapted to receive a driver or other tool.

Similar to the previously disclosed embodiment, a spring 78 and valve member 80 are preferably inserted into the oil squirter bore 66 and the novel squirter cap 74 of the present invention is then threaded into the squirter bore. Not only can the squirter cap 74 be removed to clean and service the squirter bore or passageway 66, internal components and even the oil gallery 24 may also be cleaned and serviced.

The foregoing description of the embodiments of the invention has been presented for the purposes of illustration and description. It is not intended to be exhaustive or to limit the invention to the precise forms or methods disclosed. Persons skilled in the relevant art can appreciate that many modifications and variations are possible in light of the above teaching, including but not limited to, modifications to dimensions and materials.

What is claimed is;

1. A rebuildable air cooled internal combustion engine casing tier housing and supporting a plurality of pistons and forming an oil gallery in fluid connection with a piston chamber for housing each piston, the engine casing comprising:
A first casing member having, a first planar mating surface;
A second casing member having a second mating surface generally opposing and adapted to sealably couple, with the first mating surface to form the rebuildable engine casing having a piston chamber in fluid connection with an oil gallery, the second casing member having an internal injection bore that is fluidly coupled to an oil gallery:
A tubular body secured within the injection bore, the tubular body having a receiving end adapted to be fluidly coupled to the oil gallery and extending to a discharging end;
An oil squirter cap having a first end adapted for removable attachment to the discharging end of the tubular body and a second end having an external mechanical configuration adapted to allow use of a tool when coupling and removing the cap from the tubular body.
Wherein the oil squirter cap is fluidly coupled to the tubular body for passing oil from the tubular body into the piston cavity and out though an orifice within the second end,

2. The rebuildable engine casing, of claim 1 wherein the discharging end of the tubular body further comprises internal threads that are adapted to mesh with external threads on the first end of the squirter cap.

3. The oil injection nozzle of claim 2 wherein the discharging end of the tubular body further comprises a flange adapted to seat against an opposing flange on the cap.

4. The oil injection nozzle of claim 3 wherein the mechanical configuration of the second end of the cap is adapted to mate with a mechanical tool for connection and removal from the tubular body.

5. The engine casing of claim 2 further comprising an internally threaded bore within an exterior surface, the threaded bore in fluid connection with the oil gallery and adapted to mesh with an externally threaded plug to allow for servicing of the oil gallery.

6. The engine casing of claim 2 wherein the first planar mating surface further comprises a plurality of spaced apart threaded bores passing through the first mating surface, each bore being substantially perpendicular to the first mating surface and adapted for meshing with a threaded fastener such that when threaded into the bore, the fastener increasingly presses against the mating surface of the second engine casing member.

7. The engine casing of claim 6 wherein the oil squirter cap further comprises an external slot adapted for coupling with a driver tool.

8. The engine casing of claim 3 wherein the tubular body further comprises a spring and valve member for modifying the free flow of oil into the piston chamber.

9. An oil injection nozzle for cooling a piston plan internal combustion engine by squirting ad from an oil gallery into the piston cavity within the engine casing, the oil injection nozzle comprising:
A tubular body adapted to be secured within the engine casing, the tubular body having a receiving end adapted to be fluidly coupled to the oil gallery and extending to a discharging end;
An injection cap having a first end adapted for removable attachment to the discharging end of the tubular body and a second end having an external mechanical configuration adapted to allow use of a tool when coupling and removing the cap from the tubular body.
Wherein the injection cap is fluidly coupled to the tubular body for passing oil from the tubular body into the piston cavity and out though an orifice within the second end.

10. The oil injection nozzle of claim 9 wherein the discharging end of the tubular body further comprises internal threads that mate with external threads on the first end of the cap.

11. The oil injection nozzle of claim 10 wherein the discharging end of the tubular body further comprises a flange adapted to seat against an opposing flange on the cap.

12. The oil injection nozzle of claim 10 wherein the mechanical configuration of the second end of the cap is adapted to mate with a mechanical tool for connection and removal from the tubular body.

13. The oil injection nozzle of claim 10 further comprising a spring slidably positioned within the tubular body and a valve member.

14. A rebuildable air cooled internal combustion engine casing for housing and supporting a plurality of spaced apart pistons and forming an oil gallery, the engine casing comprising:
A first casing member having a first planar mating surface:
A second casing member having a second mating surface generally opposing and adapted to seal against and connect with the first mating surface to form the rebuildable engine casing having a piston chamber in fluid connection with the oil gallery, the second casing portion having an internal bore that is fluidly coupled to the oil gallery;
An oil squirter cap having a first end adapted for removable attachment to the internal bore and a second end having an external mechanical configuration adapted to allow use of a tool when coupling and removing the cap from the internal bore.
Wherein the injection cap k coupled to the internal bore for passing oil from the oil gallery into a piston cavity within the engine casing though an orifice within the second end of the squirter cap.

15. The engine casing of claim 14 wherein the internal bore further comprises an opening into the piston cavity having internal threads adapted to mate with external threads on the first end of the cap.

16. The engine casing of claim 14 wherein the oil squirter cap further comprises a flange adapted to seat against an opposing flat surface on the second casing member.

17. The engine casing of claim 14 wherein the mechanical configuration of the second end of the cap is adapted to mate with a mechanical tool for connection and removal from the tubular body.

18. The engine casing of claim 14 further comprising a threaded plug removably coupled to an internally threaded bore within the engine casing, the threaded bore in fluid connection with the oil gallery and adapted to allow servicing of the oil gallery.

19. The engine casing of claim 14 wherein the first planar mating surface further comprises a plurality of spaced apart threaded bores passing through the first mating surface, each bore being substantially perpendicular to the mating surface and adapted for meshing with a threaded fastener such that when threaded into the bore, the fastener increasingly presses against the mating surface of the second engine casing member.

20. The engine casing of claim 19 further comprising a threaded plug removably coupled to an internally threaded bore within the engine casing, the threaded bore in fluid connection with the oil gallery and adapted to allow servicing of the oil gallery; and wherein the oil squirter cap further comprises an external slot adapted for coupling with a driver tool.
